(19) United States
(12) Patent Application Publication
(10) Pub. No.: US 2005/0049898 A1
(43) Pub. Date: Mar. 3, 2005

(54) Telemedicine system using the internet

(76) Inventor: Maiko Hirakawa, Kawasaki (JP)

Correspondence Address: Maiko Hirakawa, 4-2-1-309 Tsuchihashi Miyamae-Ku, Kawasaki, 216-0005, JP

(21) Appl. No.: 10/653,738

(22) Filed: Sep. 1, 2003

(51) Int. Cl. G06F 17/60

(52) U.S. Cl. 705/5

(57) ABSTRACT

This is the invention of a telemedicine system using internet, optical fiber, which is included medical reservation system, video conference system, e-carte, e-medical certificate, e-medical consent form and e-prescription and e-commerce. The medical examination is done using these. The consultation is possible by e-mail. Patient reserves using medical reservation system in internet, sees a doctor using a video conference system, pays by credit card by using e-commerce and gets medicine by e-prescription. Before seeing a doctor, patient submits e-medical consent form to agree on the medical examination using telemedicine system. Doctor sees a patient using video conference system, records using e-carte and prescribes using e-prescription. Inspection and medical examination between doctors are also possible. Pharmacist prescribes using e-prescription. By this system, patient soften mental burden and waist of time, doctor and pharmacist ease economical burden. Medical examination between long-distance and homemedicine are also possible.

### CROSS REFERENCE TO RELATED APPLICATIONS

U.S. patent document

1. “System, method and article of manufacture with integrated video conferencing billing in a communication system architecture”

U.S. Pat. No. 5,867,494 Feb. 2, 1999 Krishnaswamy 370/352

2. “Eye examination apparatus and method for remote examination of a patient by a health professional”

U.S. Pat. No. 6,003,991 Dec. 21, 1999 Viirre 351/206

3. “Visual Field testing via telemedicine”

U.S. Pat. No. 6,033,076 Mar. 7, 2000 Braeuning, et al. 351/224

4 “Modular video conference enclosure”

U.S. Pat. No. 6,205,716 Mar. 27, 2001 Peltz 52/36

U.S. patent application

1 “Telemedical method and system”

U.S. Pub. App. No. 20030060808 Mar. 27, 2003 Wilk, Peter J. 606/1

### BACKGROUND OF THE INVENTION

This invention belongs to the communication apparatus field and the medical technical field.

### BRIEF SUMMARY OF THE INVENTION

Although there was a problem that medical treatment was overdue since it was difficult for a patient to visit the hospital directly in the case of a remote place and a depopulated district, medical examination becomes always possible by using the video phone or video conference system attached to the internet in a personal computer or a multimedia screen which is a big and wide screen with a function of a personal computer.

In the case of a busy patient, since it was difficult to go to the hospital, there was a problem that a reservation, a medical examination, and medical treatment were overdue. An oral consultation becomes possible to by using the video phone or video conference system attached to the internet in a computer or a multimedia screen.

Even if it becomes illness suddenly somewhere in domestic and overseas or a fit happens, medical examination becomes always possible by carrying a notebook sized personal computer. Furthermore, connection between the doctors for transmitting images, such as an introduction of a patient (a transmission and reception of a letter of introduction) in case a consultation on the spot is needed and an X-ray is possible. Medical examination is also possible between doctors.

A mental burden becomes large and not receiving the medical treatment which attains to a long period of time has a possibility that condition of disease may become more serious. However, a consultation by being home becomes always possible by using the video phone and the video conference system attached to the internet and the hospital network on a personal computer or a multimedia screen.

By using the 24-hour reservation system, the problem that the reservation is impossible since reservation time is restricted, is solved and patient can always reserve.

It becomes possible to receive medicine without waiting by using the pharmacy prescription on-line after oral consultation. It solves a problem that the waiting time is in a pharmacy is too long. Moreover, in the case of a remote place or a depopulated district, it becomes possible to receive medicine by using the next-day delivery service.

Will understanding of a doctor and a patient may be difficult during medical examination. Although a doctor depends on the reason that it is busy or a patient cannot tell a doctor an opinion easily, will understanding of them is attained by using the e-mail function attached to the internet in a personal computer or a multimedia screen.

Although there is a distrust to the doctor of the patient by not knowing how medical examination is progressing, it becomes possible to soften the distrust to a doctor by exhibiting an e-carte only to a patient individual on on-line. Before starting the medical examination, patient is required to submit e-medical consent form that patient agree on the medical examination using this telemedicine system using internet.

The estranged feeling to a hospital can be softened by using the video phone or video conference system which is attained to the internet in a personal computer or a multimedia screen as a connection means of a patient and a hospital.

Although just the oral consultation of the medical examination is inadequate, an inspection for which a numerical value is needed by connecting a measuring instrument to a personal computer or multimedia screen is attained.

### BRIEF DESCRIPTION OF THE SEVERAL VIEWS OF THE DRAWING

There is the operation of a bibliography with figures. These figure shows an example of how to see a doctor for patient, how to make a reservation, how to receive a medicine. There are also figures showing how to use this system for a doctor and pharmacist in a pharmacy.

There are screens of a medical examination for patient from a FIG. 1 to 20.

By operation from a FIG. 1 to 6, a patient can get to the screen of a medical examination using a video conference system. A patient clicks Next or proper words or sentence and goes to a next screen.

By clicking a screen of FIG. 1, a patient get to a screen of FIG. 2. A patient click on his demand. In this example, “see a doctor” is chosen. In FIG. 3, a patient clicks after choosing a department. FIG. 4 shows a screen of choosing whether he reserved or not.

In FIG. 5, a patient enters his name, a number of a reservation, a credit card No. and clicks to next. In FIG. 6, there is a confirmation of a reservation.

FIG. 7 shows a screen of a medical examination. A patient sees a doctor using a video conference system on the internet and a headset. A headset is a headphone with a microphone. If any inspection is needed, it is possible by using a measuring instrument attached to a communication apparatus.

FIG. 8 shows a screen of an instruction after a medical examination. A patient clicks next and checks e-presentation. If there is any correction, a patient enters right data in FIG. 10. A hospital asks a fee in FIG. 11. If a medical certificate is needed, a patient enters a reason and the name of a recipient in FIG. 12. A doctor checks the data that was entered then publishes a medical certificate in FIGS. 13 and 14. FIG. 15 shows a screen of the end of medical examination.

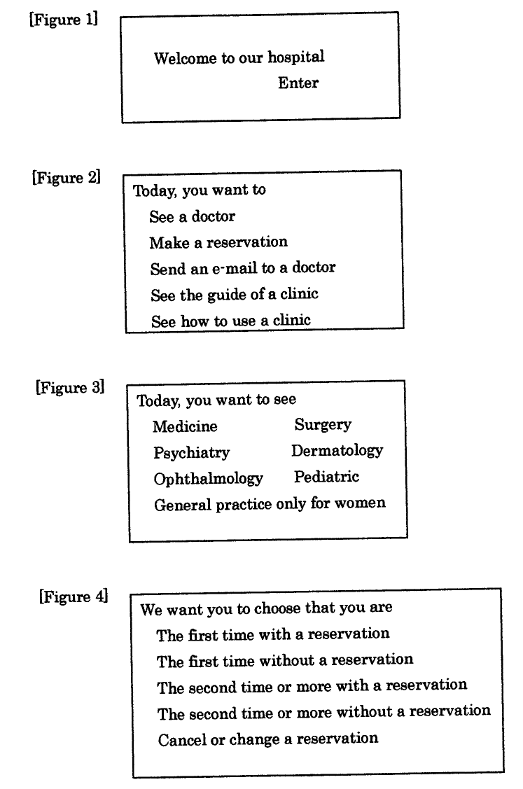

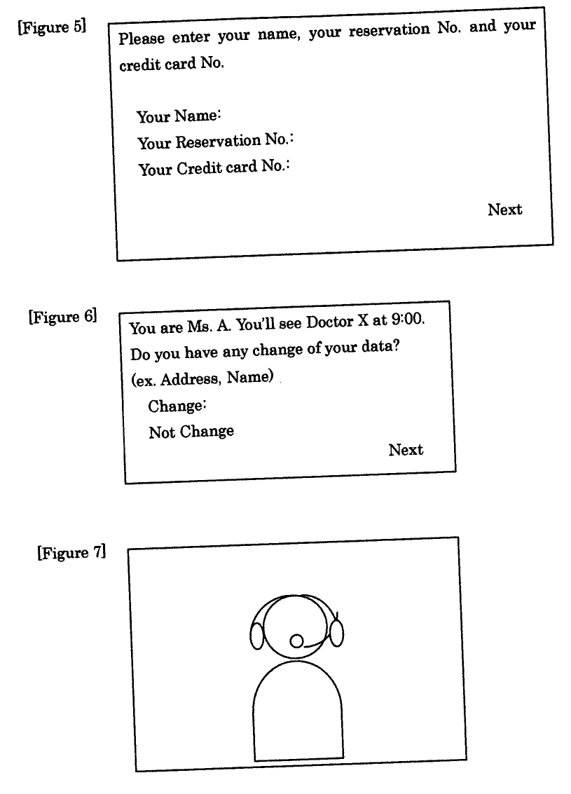

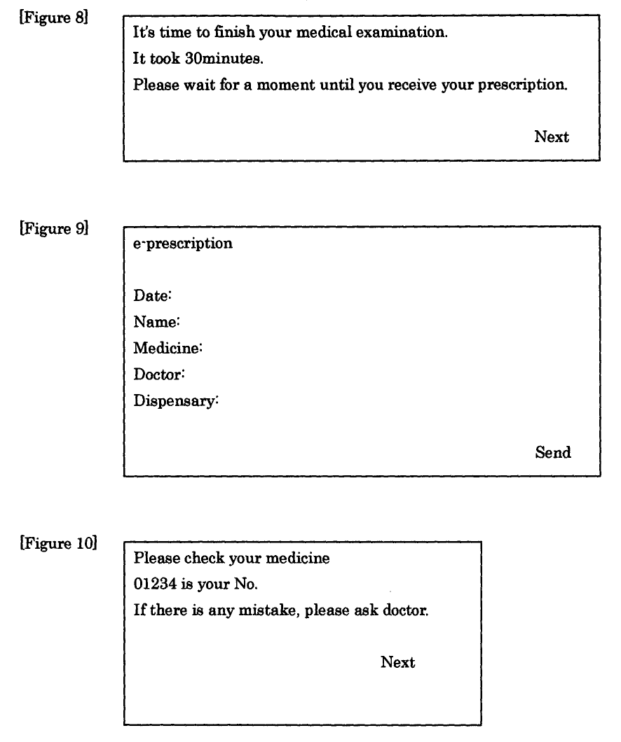

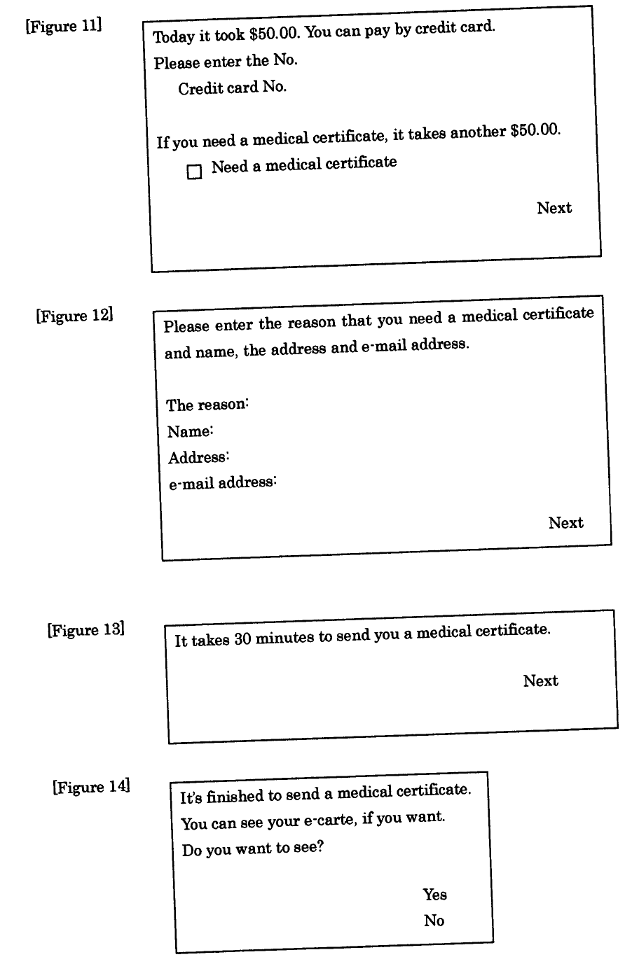

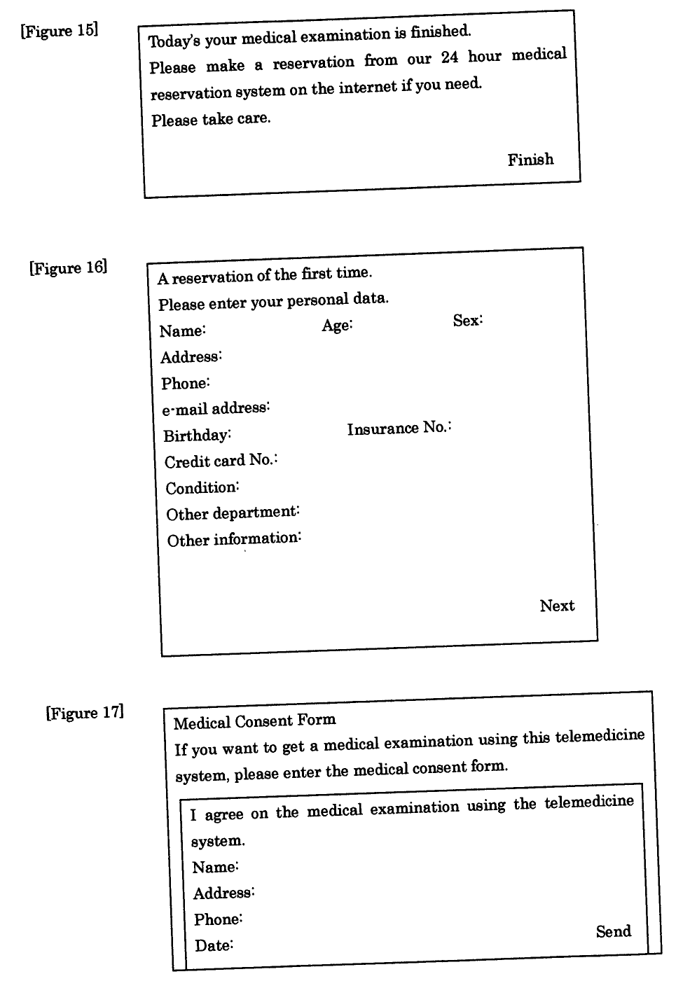

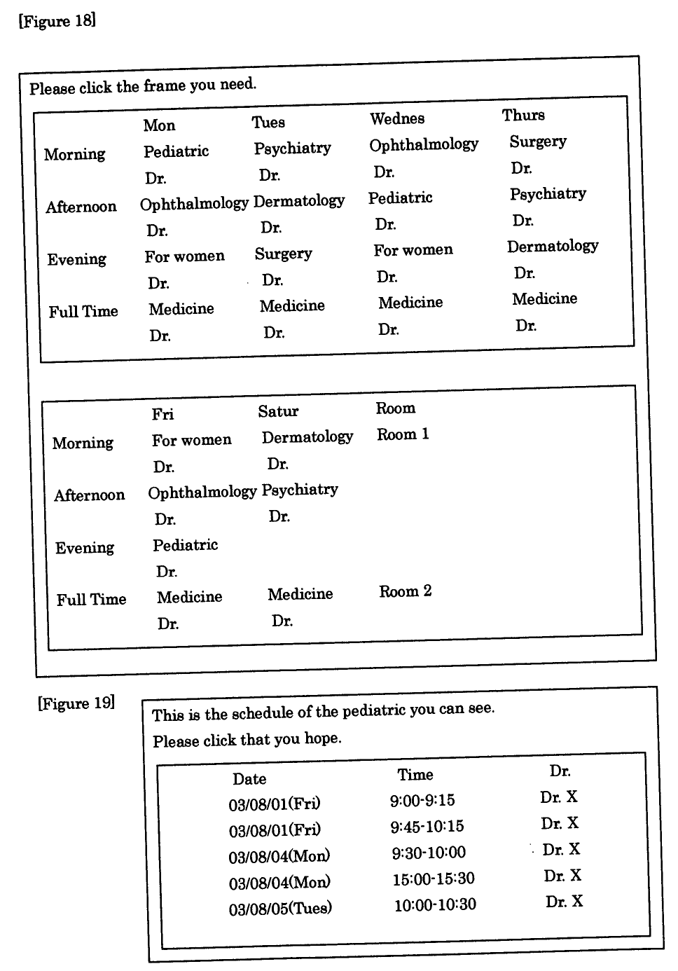

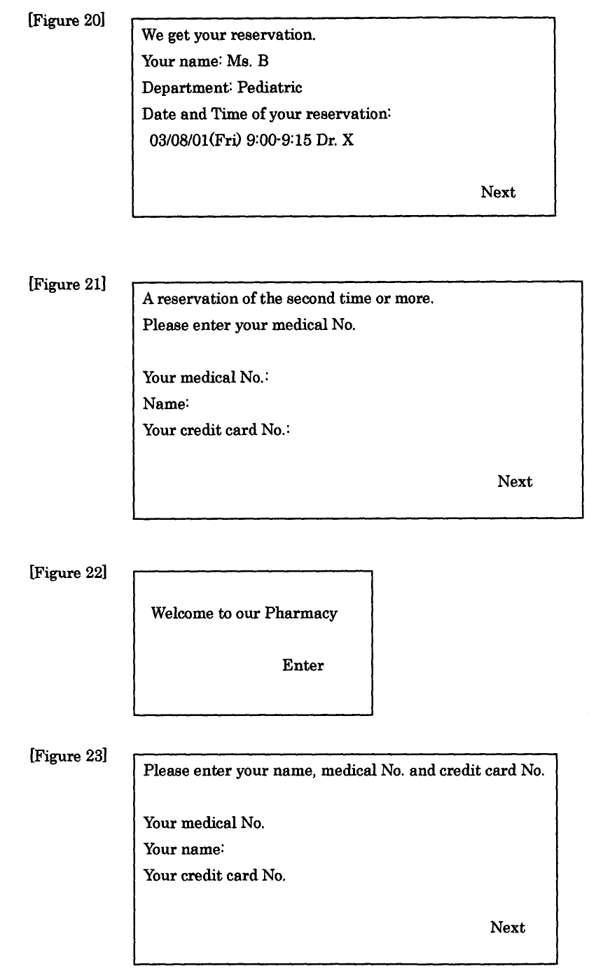

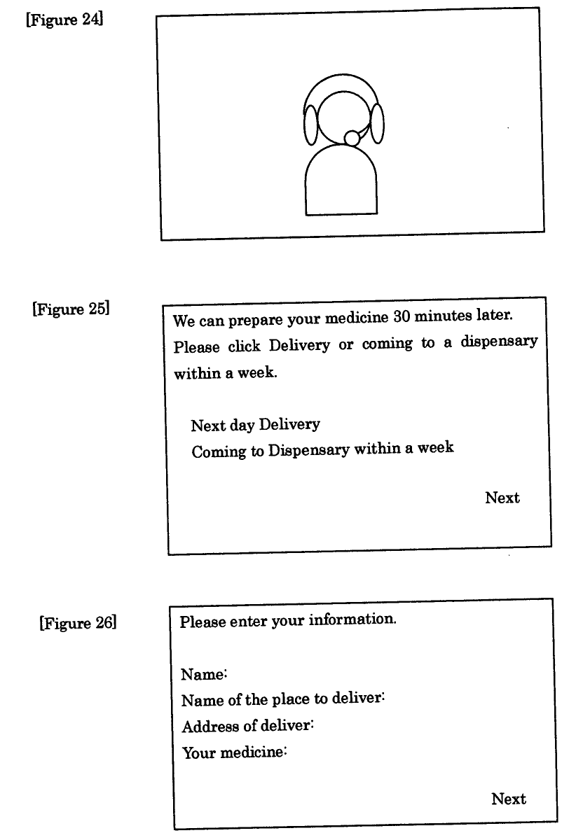

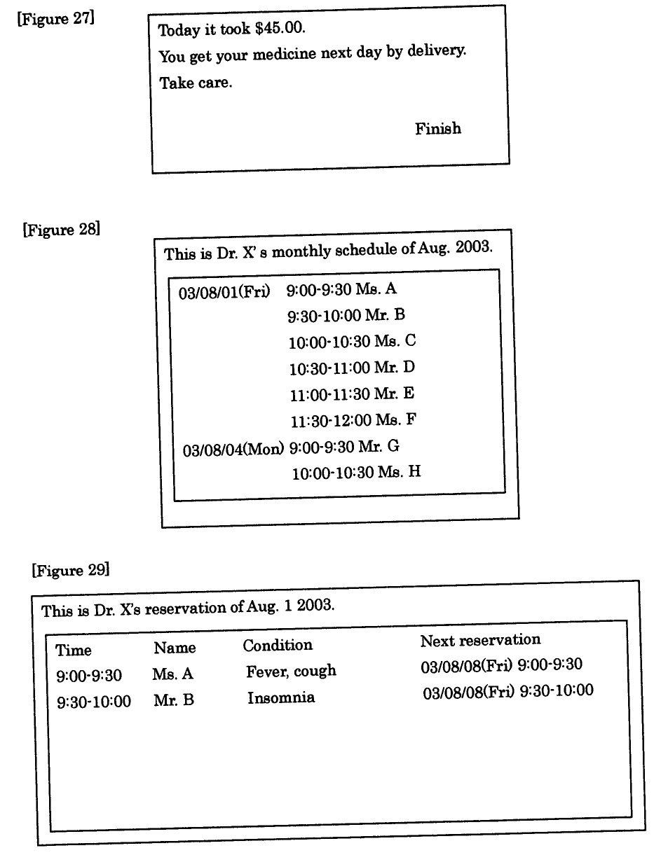

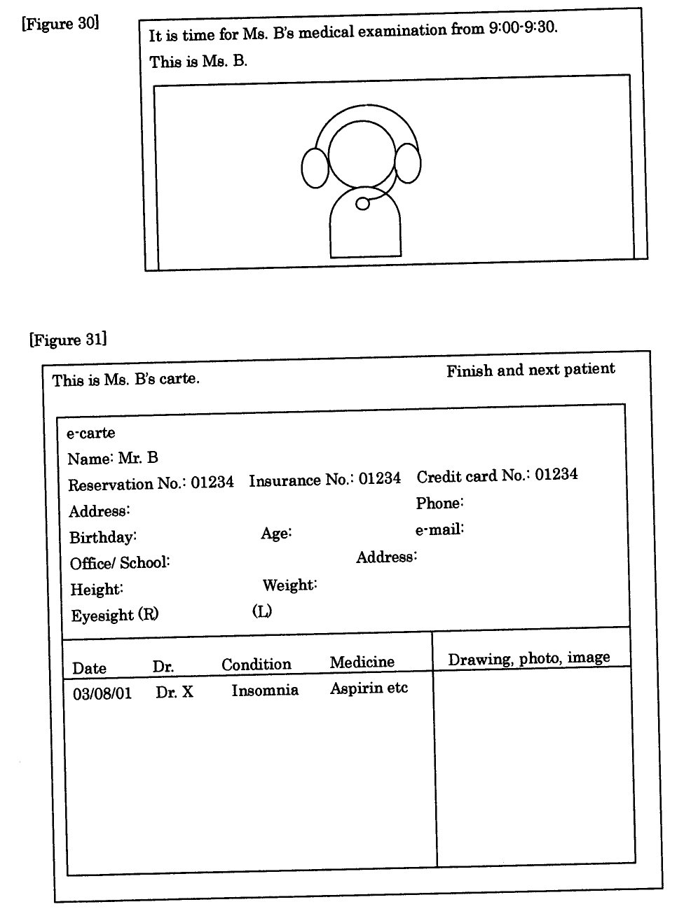

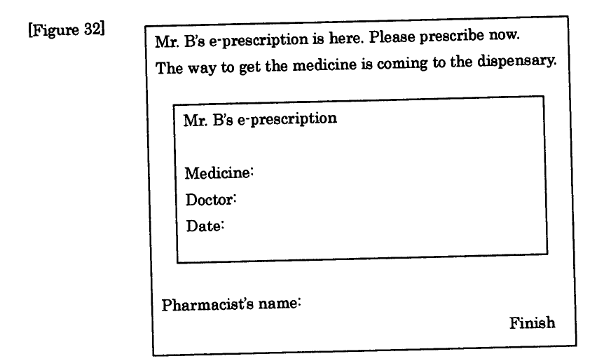

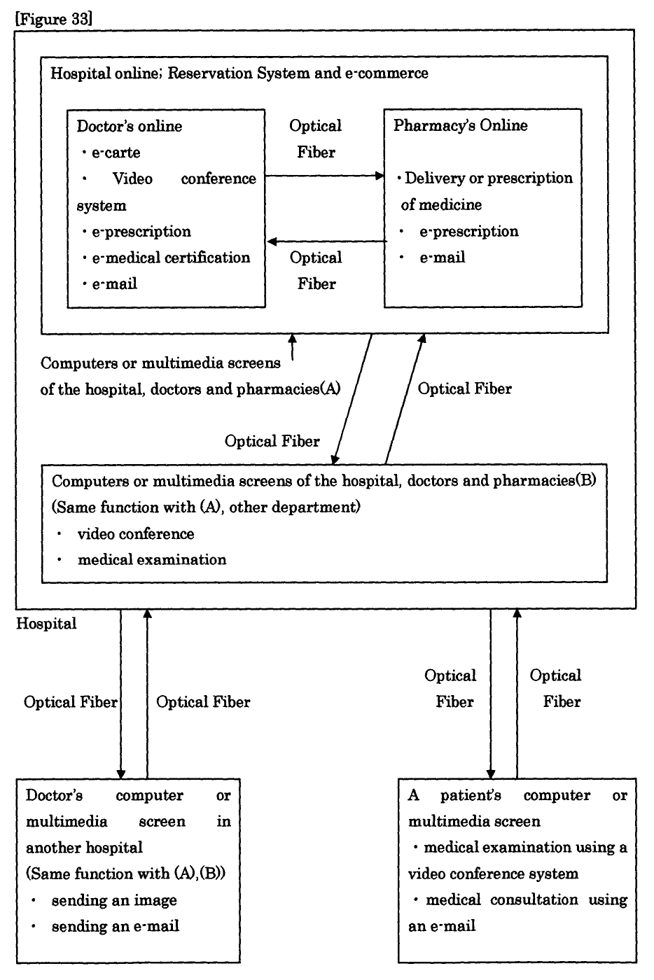

A patient can see an e-carte in FIG. 31. An e-carte is opened only for a patient himself.

A patient goes back to a screen of FIG. 1. If a reservation is needed then a patient goes to a screen of FIG. 2.

From FIG. 16 to 21, there is a screen of reservation.

In FIG. 2, “Make a reservation” is chosen and a patient goes to FIG. 4. “The first time without a reservation is chose here to reserve the first medical examination and a patients goes to a screen of FIG. 16. From FIG. 16 to 19, data are entered and checking in a screen of FIG. 19. After that, a patient goes back to a screen of FIG. 1.

If a patent chooses the second time or more without a reservation in FIG. 4, then he goes to FIG. 21 and FIG. 6 then FIG. 20. From FIG. 17 and FIG. 18, data were entered and patient goes to a FIG. 19.

From FIG. 22 to 27, there is a screen of a prescription of a pharmacy. These figure are for a patients.

By clicking a screen of FIG. 22 and a patient goes to a screen of FIG. 23. In FIG. 23, data are entered and a method of getting a medicine is chose in FIG. 25. If it is a remote places, next-day delivery is chosen. Data entered are checked in FIG. 26. If visiting a pharmacy is chosen, it's the end of the medical examination. If a next-day deliver is chosen, a patient enters the address, checks data in FIG. 26, finishes in a FIG. 27 and goes back to the screen of FIG. 22.

There are screens of a medical examination for a doctor from FIG. 28 to FIG. 31. FIG. 28 and FIG. 29 are screens of the schedule of a doctor. A doctor knows that a patient visits a hospital in FIG. 30 and an e-carte is showed in FIG. 31. FIG. 30 shows a screen of an oral consultation using a video conference system. At the end of a medical examination, doctor clicks Finish and Next Patient in FIG. 31. If there is a need of entering data to an e-carte, a doctor chooses to click and a doctor goes to a screen of FIG. 30. If there is a need of an entering a data to a prescription, he chooses it in FIG. 9, signs his name with an electronic pen, and sends it to a pharmacy. After one patient is finished to see, next patient is chosen in FIG. 30 by clicking Finish and Next Patient.

FIG. 32, these are screens for a pharmacist in a pharmacy. A prescription is done by an operation of screens.

FIG. 33 shows the use of an on-line between a doctor and a patient, a doctor and a pharmacy and a pharmacy and a patient. Optical fiber is used for online.

By choosing a consultation in FIG. 2, it is possible for a patient to consult a doctor using an e-mail, and by choosing a guide of a hospital and how to use a hospital. A patient is possible to understand a method of a medical examination of the hospital.

### DETAILED DESCRIPTION OF THE INVENTION

The medical examination using the communication apparatus performed in a conventional remote place and a conventional depopulated district was a part of geriatric medicine which used videophone.

Conventionally, since a medical examination and reservation were hospital bases, they become a burden in many cases for the patient. Therefore, visiting to the hospital became too difficult, condition progressed, and the problem of becoming too bad existed. In order to solve a problem, it becomes possible to perform reservation and a medical examination of a patient basis by the internet or using the video conference system and e-mail. Moreover not only an old man but also busy people, such as businessmen and businesswomen with a difficulty to visit to the hospital, are also applicable.

In order to solve the above-mentioned problem, the video conference system with a headset and e-mail function attached to the internet on the existing personal computer or a multimedia screen are used. A patient receives a medical examination, a prescription, and a medicine with the above technology for 24 hours somewhere in domestic and overseas. A reservation and getting a medicine are also possible to be applied.

This invention is a medical examination system using a video conference system, a medical reservation system, e-carte, e-prescription, e-medical certificate, e-medical consent form, on-line pharmacy and e-commerce in a internet in a personal computer or a multimedia screen and used in the remote place and depopulated district. Patient reserves using the online reservation system, sees a doctor using a video conference system with a headset, pays by credit card using e-commerce system, gets medicine by e-prescription. Doctor sees patient using a video conference system, records using e-carte, prescribes using e-prescription, gets will understandings using e-medical consent form and e-medical certificate. Pharmacist prescribes medicine by e-prescription and get fee by e-commerce. The multimedia screen that is a big and wide screen with a function of a personal computer is also used by a patient, a doctor and a pharmacist for a medical examination.

By using this new system, a patient can see a doctor at his own house, so a condition proceeding and becoming too badly are prevented. Moreover by using a notebook sized personal computer, it is possible for a patient with a fit to receive a medical examination in an emergency, such as to happen, at a going-out place. It is also used between doctors. By using this system, a consultation, medical examination, sending an image are possible.

Optical fiber is used for the online to get a proper medical examination.

1. The online 24 hour medical reservation system using the internet

2. The online medical examination system using the video conference system with a headset, e-carte, e-medical certificate, e-prescription, e-medical consent form and e-commerce in the internet.

3. The online pharmacy system using the e-prescription and the e-commerce in the internet.
